(19) United States
(12) Patent Application Publication
(10) Pub. No.: US 2019/0075069 A1
(43) Pub. Date: Mar. 7, 2019

(54) BEHAVIORALLY MODELLED SMART NOTIFICATION REGIME

(71) Applicant: QUALCOMM Incorporated, San Diego, CA (US)

(72) Inventors: Akash KUMAR, Hyderabad (IN); ANKITA, Hyderabad (IN); Ashutosh GIRI, Patna (IN)

(21) Appl. No.: 15/694,444

(22) Filed: Sep. 1, 2017

(51) Int. Cl. H04L 12/58

(52) U.S. Cl. CPC H04L 51/24; H04L 51/20; H04L 51/38

(57) ABSTRACT

A method, an apparatus, and a computer-readable medium for behaviorally modelled smart notifications are provided. The apparatus analyzes first information associated with at least one user of an apparatus, and analyzes second information associated with a message received on the apparatus. The further compares the first information with the second information, and generates an alert instruction for indicating that the message is received, the alert instruction including one or more characteristics of an alert, the one or more characteristics being based on a result of the comparing. In an aspect, the apparatus may be configured to generate the alert based on the alert instruction.

### BACKGROUND

### Field

The present disclosure relates generally to communication systems, and more particularly, to a behaviorally modelled smart notification regime.

### Background

Wireless communication systems are widely deployed to provide various telecommunication services such as telephony, video, data, messaging, and broadcasts. With extended functionalities of smartphones, users frequently receive multiple notifications of incoming messages. Notifications may include alerts from incoming calls, incoming messages, or pop-up notifications on applications. Notifications for all incoming messages can be a cause of inconvenience and distraction to the user especially for notifications of incoming messages that the user is not interested in either based on a type of message, the content of the message, or based on the message sender.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

As discussed supra, extended functionalities of smartphones, include frequent notifications that may cause inconveniences and distractions to the user. This is especially true for notifications in which the user has no interest either based on a type of message or based on the message sender. Conventionally, an ability to tailor a smartphone to the user's needs is limited. For example, conventionally, a user is limited to the ability to adjust a characteristic, such as volume, for all notifications from a particular application, adjust the characteristic for all notifications on a device based on the user's calendar/location, or adjust the characteristic for all notifications on a device based on the user's proximity to a device.

In an aspect of the disclosure, a method, an apparatus, and a computer-readable medium for behaviorally modelled smart notifications are provided. The apparatus may obtain first information associated with a recipient of a message received on the apparatus. The apparatus may also obtain second information associated with the message. Further, the apparatus may determine a context of the message based on the first information and the second information. The apparatus may determine an importance level of the message based on the context. The apparatus may also generate an alert instruction for indicating that the message is received. The alert instruction may include one or more characteristics of an alert. Further, the one or more characteristics may be based on the importance level

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows an example wireless communication system.

FIG. 2 is a conceptual diagram of an exemplary apparatus with a behavioral notification function.

FIG. 3 is a functional block diagram of an apparatus that may be employed by FIG. 2.

FIG. 4 is a flowchart of methods of an exemplary operation of an apparatus with behavioral notification functions.

FIGS. 5A-5B are flowcharts of methods of an exemplary operation of an apparatus with behavioral notification functions.

FIG. 6 is a conceptual data flow diagram illustrating the data flow between different modules/means/components in an exemplary apparatus.

FIG. 7 is a diagram illustrating an example of a hardware implementation for an apparatus with behavioral notification functions.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

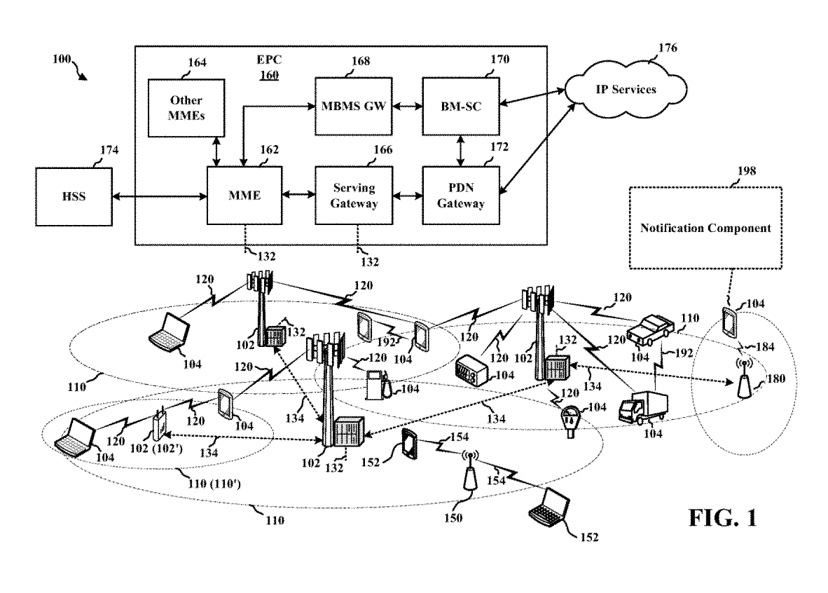

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links may be through one or more carriers. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., wearables, parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an aspect, the UE 104 may include one or more components for performing various functions. In one example, the UE 104 may include a notification component 198 configured to obtain first information associated with a recipient of a message received on the UE 104, obtain second information associated with the message, determine a context of the message based on the first information and the second information, determine an importance level of the message based on the context, and generate an alert instruction for indicating that the message is received, the alert instruction including one or more characteristics of an alert, the one or more characteristics based on the importance level. In an aspect, the UE 104 may be configured to generate the alert based on the alert instruction.

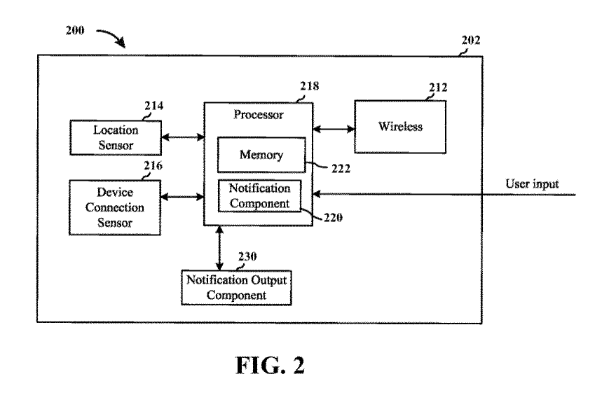

FIG. 2 is a conceptual diagram 200 of an exemplary apparatus 202 with a behavioral notification function that may use sensor data. The apparatus 202 may be, for example, a cell phone, a tablet computer, a wearable with wireless communication capability, or any other device with wireless communication capability. Further examples of the apparatus 202 may include UE 104. The apparatus 202 may include a wireless communication component 212, sensors 214, 216, and a processor 218. The processor 218 may further include a notification component 220 and memory 222. The notification component 220 may be configured to control and manage notifications associated with applications on the apparatus 202, as described supra. In an example, the notification component 220 may perform the function of the notification component 198. The memory 222 may be used for storing data that is manipulated by the processor 218 when executing software.

The wireless communication component 212 may include, for example, an antenna and other components for sending and receiving communications over a wireless communication channel. The communications may be provided to/from the processor 218.

Examples of the wireless communication via the wireless communication component 212 may include various telecommunication services such as telephony, video, data, messaging, and broadcasts. Moreover, the wireless transmitting and receiving of signals may be under various telecommunication standards. Example telecommunication standards may include the standards described supra for wireless communication system 100 including peer-to-peer communications standards.

The location sensor 214 may detect, for example, location characteristics of the apparatus 202 and provide location data to the processor 218. Examples of the location sensor 214 may include accelerometers that measure linear acceleration and/or rotation angle of the apparatus 202, gyroscopes that measure the angular rate of rotation of the apparatus 202 about one or more axes for tracking the position of a moving object such as the apparatus 202, digital compasses (e.g., eCompasses) that detect heading of the apparatus 202 based on the Earth's magnetic field, pressure sensors that measure relative and absolute altitude of the apparatus 202 through the analysis of changes in the atmospheric pressure, inertia sensors (e.g., microelectromechanical systems or MEMS) to produce a three-dimensional measurement of force and angular rate of the apparatus 202 in combination with outputs of accelerometers and gyroscopes, or positioning systems (e.g., Global Positioning System, indoor positioning systems, or mobile tracking systems), or any combination of the examples.

The device detection sensor 216 may detect, for example, connection and/or location characteristics of one or more devices (e.g., watch) coupled to the apparatus 202 (e.g., smartphone) through one or more wireless protocols and provide device detection data to the processor 218. The detected location may be in reference to a location or proximity of the one or more coupled device in relation to the apparatus 202. Further, the detected location may be based on a time a message is received by the apparatus 202. In some examples, the device detection sensor 216 may detect or sense an activity or movement of the one or more coupled devices in relation to the apparatus 202, the location may be based on the detected activity or movement. Examples of the device detection sensor 216 may include a Bluetooth tracking technology, a radio frequency identification (RFID) tracking technology, wireless fidelity (Wi-Fi) tracking technology, or any technology that facilitates the apparatus 202 in receiving connection and/or location characteristics of the one or more coupled devices.

The processor 218 may interface with the wireless communication component 212, the location sensor 214, and the device detection sensor 216. In some examples, the processor 218 may be or be part of an application processor of the apparatus 202. In some examples, the processor 218 may be implemented on one or several dies. The processor 218 may provide the transmission data to and receive the data from the wireless communication component 212. The processor 218 may further monitor and receive data from the location sensor 214 relating to certain location characteristics of the apparatus 202, such as data on the location of the apparatus 202, or from the device detection sensor 216, relating to certain connection or location characteristics of one or more coupled devices, such as data on the location or proximity of the one or more coupled devices.

The processor 218 may include a notification component 220, which handles various features of the exemplary notification functions described herein. The notification component 220 may be configured to obtain first information associated with a recipient of a message received on the device, obtain second information associated with the message, and determine a context of the message based on the first information and the second information. The notification component 220 may be further configured to determine an importance level of the message based on the context and generate an alert instruction for indicating that the message is received. In this example, the alert instruction may include one or more characteristics of an alert, and the one or more characteristics may be based on the importance level.

In an aspect, the apparatus 202 may also include a notification output component 230, as shown by FIG. 2. Examples of the notification output component 230 may include a display, a speaker, a vibration motor, a light emitting diode (LED), or any other component that may function in generating an alert to notify receipt of a message.

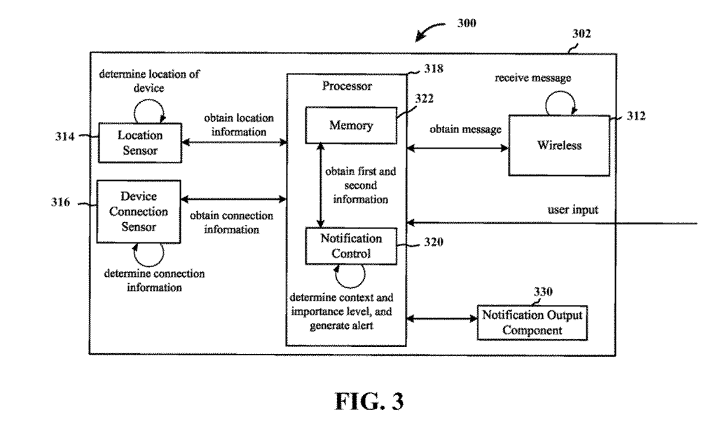

FIG. 3 is a functional block diagram 300 of an exemplary apparatus 302 that may be employed by FIG. 2. Examples of the apparatus 302 may include UE 104. The apparatus 302 may include a wireless communication component 312, sensors 314, 316, a notification output component 330, and a processor 318. Examples of the wireless communication component 312, sensors 314, 316, the notification output component 330, and a processor 318 may include the wireless communication component 212, sensors 214, 216, notification output component 230, and a processor 218, respectively. The processor 318 may further include a notification component 320 and memory 322, examples of which may include the notification component 220 and memory 222.

In an example, the wireless communication component 312 may receive a message. The processor 318 may obtain the message for processing. The notification component 320 may obtain first information associated with a recipient of the received message. The first information may include a plurality of factors that include information associated with a recipient's interests and priorities. The first information may be based on information associated with past messages associated with the recipient or application data (e.g., web browser searches or calendar appointments) associated with the recipient. The first information may be based on information associated with a response time by the recipient to a message from an application (or type of application), a messages from a sender (or category of sender), or content of past messages. For example, the first information may include a user's interests and priorities related to different applications, sender's of past messages, content of past messages, and content of application data, recipient's response time to messages based on location or time of messages when received or transmitted. The first information may be information stored on the apparatus 302, may be information obtained from another device such as a central server, or may be information obtained from one or more devices coupled to the apparatus 302.

In this example, the notification component 320 may obtain second information associated with the message. The second information may include a plurality of factors that may include at least one of information regarding the content, sender, or recipient of the message, or the location or the time associated with the message. The location associated with the message may include at least one of a transmitted location or a received location. The time associated with the message may include at least one of a date, a time, or a time zone associated with a message (e.g., the date, the time, or the time zone of when the message was transmitted or received). For example, the notification component 220 may be configured to determine the time zone of the sender or the apparatus 202. Further, the notification component 220 may be configured to determine the time associated with the message (e.g., the date, the time, or the time zone of when the message was transmitted or received) based on the location associated with the message (e.g., the transmitted location or the received location).

The information associated with the received location of the message may be based on the location of the apparatus 302 when the message is received. The apparatus location may be obtained from the location sensor 314. In some configurations, the detected location may be in reference to a location of the apparatus 302 at a time the message is received by the apparatus 302. In some examples, the location sensor 314 may detect or sense an activity or movement of the apparatus 302, the location may be based on the detected activity or movement. The information associated with the transmitted location of the message may be obtained through the message, or through a prompt sent to the sender of the message. In this example, the prompt may request for the location from where the message was transmitted. The prompt may include a request for auto detection of the sender's location.

In the example, the notification component 320 may determine a context of the message based on the first information and the second information. A context of the message may include a comparison of the factors of the second information in relation to factors of the first information. In this example, the context may be determined based on whether past messages from the application associated with the message have been characterized as important; whether past messages from the sender associated with the message have been characterized as important; whether content of past messages associated with the received message have been characterized as important; or any other second information that is associated with the first information has been characterized as important. The characterization may be done by the notification component 320. Examples of characterizing the first and second information may include using calendar information, such as a meeting time and invitees/attendees of a meeting, to determine a relationship of the of the sender of the message and the reception time of the message to the calendar information (the context).

In the example, the notification component 320 may determine an importance level of the message based on the context of the message. In this example, the notification component 320 may evaluate the importance of each of the factors obtained for the first information and the second information and determine an overall importance level based on all the factors. Further, the notification component 320 may assign different weights to one or more of the factors depending on the individual factor. In an aspect, the weights may be a ranking score of the different factors such as applications, message senders, content of messages etc., In this example, the ranking may be based on, for example, a recipient's interest levels in the past to the application associated with a message, a sender of the message, content of the message, time (either sender or receiver times) associated with the message, or location (either sender or receiver locations) associated with the message. The ranking score for each of the factors may be summed to obtain an overall importance level for the message. In another aspect, the weights may be based on a relationship of the factors with each other. In some examples, the relationship may include a timing of a message in relation to calendar events. In some examples, the relationship may include a location of a sender of a message in relation to a location of the recipient. Further, a ranking of the factors may be determined based on the relationship. As an example, the notification component 320 may obtain calendar application data, including information regarding attendees and start/stop times of a meeting (i.e., first information) and, in comparison with a sender of a message and a reception time of the message (i.e., second information), may weigh the sender and reception time factors high because the sender is one of the attendees of the meeting and the message is received within a certain time period before/after the start/stop time of the meeting. As another example, the notification component 320 may obtain calendar application data, including information regarding attendees of a meeting, location of the meeting, and start/stop times of the meeting (i.e., first information) and, in comparison with a sender of a message, a location of the recipient, and a reception time of the message (i.e., second information), may weigh the sender, the location, and the reception time factors high because the sender is one of the attendees of the meeting, the recipient is located near the meeting, and the message is received within a certain time period before/after the start/stop time of the meeting.

In the example, the notification component 320 may generate an alert instruction for indicating that the message is received. In this example, the alert instruction may include one or more characteristics of an alert, and the one or more characteristics may be based on the determined importance level. Examples, of the characteristics of the alert may include a sound or volume of a speaker, a notification message on a display, a blinking pattern of an LED, or a vibration pattern of a vibration motor, or any combination of these examples.

In another aspect, the notification component 320 may analyze the first information by retrieving connection information. The connection information may be associated with one or more device coupled to the apparatus 302. The connection information may include a message received on the one or more devices, application information obtained by one or more devices (e.g., information related to a calendar application or a messaging application), a user of the one or more devices, or a proximity of the one or more coupled devices to the apparatus 302 (e.g., a proximity of the one or more coupled devices at a current time or at a past time). The notification component 320 may retrieve the connection information from the one or more devices coupled to the apparatus 302 or from information stored on a central server. The information stored on the central server may be updated periodically by the apparatus 302 or the one or more devices coupled to the apparatus 302.

In another aspect, the notification component 320 may obtain third information including at least one of a power state of the apparatus 302 or an amount of data remaining in a data plan associated with the apparatus 302. Further, the one or more characteristics of the alert instructions may be further based on the third information. In an example, the notification component 320 may read a power state of the apparatus 302 and, when the power state is low, may generate alert instructions for only those messages having an importance level above a predetermined threshold (e.g., the most important messages threshold) to conserve power for the apparatus 302. In another example, the notification component 320 may read an amount of data remaining in a data plan associated with the apparatus 302 and, when the amount of data remaining is below a predetermined amount, may generate alert instructions for only those messages having an importance level above a predetermined threshold (i.e., the most important messages) to conserve data amounts for the apparatus 302.

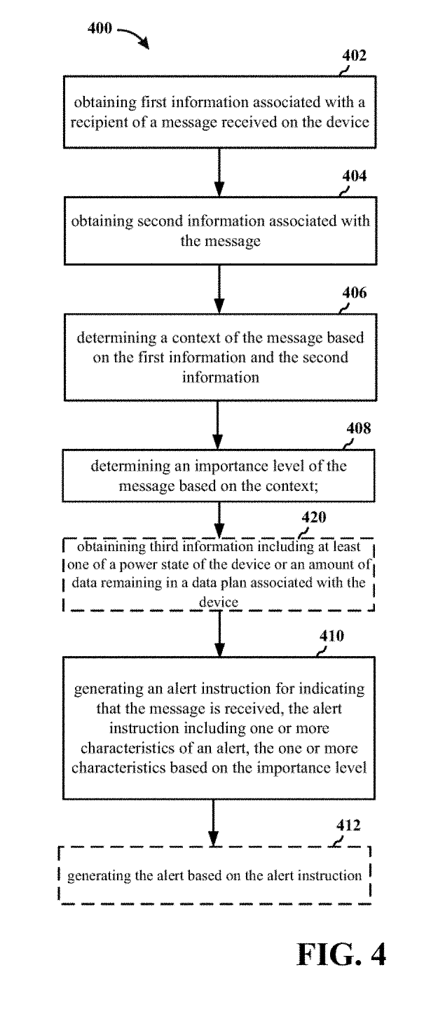

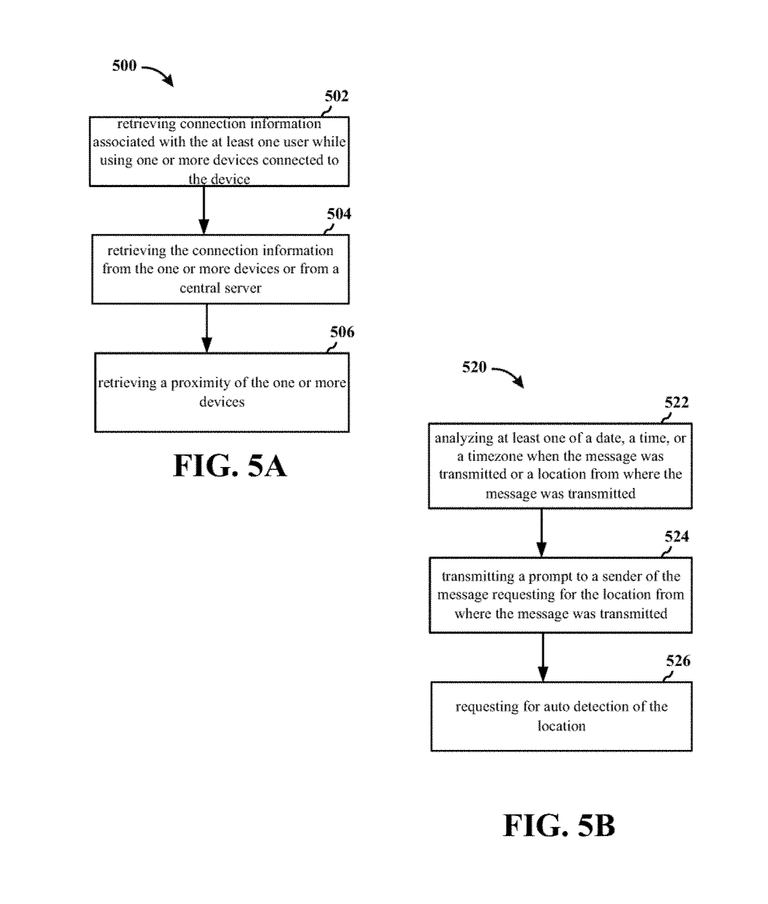

FIGS. 4, 5A-5B are flowcharts 400, 500, 520 of methods of an exemplary operation of an apparatus with behavioral notification functions. The methods may be performed by, for example, UE 104 or any one of the apparatuses 202, 302. At 402, the apparatus may obtain first information associated with a recipient of a message received on the device. For example, when obtaining first information, the apparatus may determine behavioral information associated with a user's interests and priorities given to different applications on the apparatus, the apparatus may determine behavioral information associated with the user's interest to message senders, the apparatus may determine behavioral information associated with the content of messages or content of web searches, or other application data, the apparatus may determine behavioral information associated with locations associated with the messages, the apparatus may determine behavioral information associated with date/time/time zone associated with messages, or any combination of the factors, as described supra.

Examples of the above factors may include the apparatus analyzing a user's response time to certain types of messaging applications such as Gmail or Yahoo mail by immediately reading emails received by the certain types of messaging applications as compared to a delayed viewing of messages received on other messaging applications. In another example, the apparatus may analyze a user's response time to certain contacts (i.e., message senders) faster than other contacts or message senders. For example, the apparatus may determine that a user reviews and responds to sender A's texts immediately but delays reviewing or responding to texts from sender B. In an example, the apparatus may determine behavioral information associated with the user's specific and general interests by determining interests of the at least one user based on web browsing and purchases made through use of applications on the apparatus. In another example, the apparatus may analyze the content of a message and a user's response time to a message based on the content. For example, the apparatus may determine that the user is interested in gadgets based on the user's immediately reviewing emails containing gadgets and purchasing gadgets through different applications.

In another example, the apparatus may obtain a location where past messages were received or by a location from where past messages were transmitted. In this example, the apparatus may determine a user's interests based on response time to messages at the received location. For example, the apparatus may determine a user's response time to types of applications, message senders, or the content of the message when the user is in the user's office as compared to when the user is in the user's home. Further, the apparatus may determine response times to messages based on the transmitted location to determine a user's interests. For example, the apparatus may determine that a user responds to messages from a transmitted location that is the same as the user's current location (e.g., East Coast of the United States) as compared to a transmitted location that has a different time zone (e.g., India). In another example, the apparatus may determine that a user responds to messages from a transmitted location such as a police station or hospital as compared to a grocery store or shopping mall.

In an example, the apparatus may analyze date/time/time zone of past messages by determining at least one of a date/time/time zone when past messages were received or transmitted. For example, the apparatus may determine a user's response time to types of applications, message senders, or the content of the message based on a date or a time the message was received or transmitted. For example, the apparatus may determine behavioral information based a user's response time to messages received on an application over a weekend as compared to messages received on the application over a weekday. As another example, the apparatus may determine behavioral information based on a user's response time to messages from a first time zone (e.g., India Standard Time) as compared to messages received from a second time zone (e.g., Eastern United States Standard Time).

As shown by FIG. 5A, in an aspect, when obtaining the first information, the apparatus may retrieve connection information associated with the at least one user while using one or more devices coupled to the apparatus (502). Further, when retrieving the connection information, the apparatus may retrieve the connection information from the one or more devices coupled to the apparatus or from a central server (504). In an example, when retrieving the connection information, the apparatus may retrieve a proximity of the one or more devices coupled to the apparatus (506) at a current time (e.g., proximity information obtained from the one or more devices) or at a past time (e.g., proximity information obtained from the central server).

At 404, the apparatus may obtain second information associated with the message received on the apparatus. The second information may include information related to the application associated with the message, the sender of the message, the content of the message, time associated with the message, or location associated with the message. As shown by FIG. 5B, in an example, the second information may include such factors as a date, a time, or a time zone in which the message was transmitted or a location from where the message was transmitted (522). In another example, the apparatus may transmit a prompt to a sender of the message requesting for the location from where the message was transmitted (524). In another aspect, the prompt may request an auto detection of the location of the sender (526). For example, the prompt may request that a device associated with the sender transmit the location of the sender, without the sender's input. However, in other examples, the prompt may request that a sender input the location before the location is transmitted to the apparatus.

At 406, the apparatus may determine a context of the message based on the first information and the second information. When determining the context of the message, the apparatus may compare all of the factors of the second information in relation to factors of the first information to determine an importance of each of the factors of the second information individually. At 408, the apparatus may determine an importance level of the message based on the context of the message. When determining the importance level, the apparatus may evaluate the importance of each of the factors obtained for the first information and the second information and determine an overall importance level based on all the factors. For example, the apparatus may assign different weights to one or more of the factors depending on the individual factor. In an aspect, the weights may be a ranking score of different applications, message senders, content of messages etc., In this example, the ranking may be based on, for example, a recipient's interest levels in the past to application associated with a message, a sender of the message, content of the message, time (either sender or receiver times) associated with the message, or location (either sender or receiver locations) associated with the message. The ranking score for each of the factors may be summed to obtain an overall importance level for the message. In another aspect, the weights may be based on the factors in relation with each other, such as timing of a message in relation to calendar events, or location of sender of a message in relation to location of the recipient, and a ranking of the factors may be determined based on the relationship. As an example, the apparatus may obtain calendar application data, including attendees and start/stop times of the meeting in comparison with a sender, and a reception time of the message and may weigh these factors high because the sender is one of the attendees of the meeting and the message is received within a certain time period before/after the start/stop time of the meeting.

At 410, the apparatus may generate an alert instruction for indicating that the message is received. In this example, the alert instruction may include one or more characteristics of an alert. The characteristics may include a type of alert, a volume of the alert, a time to implement the alert, a priority of the alert, a tag to be incorporated within the alert, or a device in which to implement the alert. Further, the one or more characteristics may be based on the determined importance level. In an aspect, the apparatus may queue alert instructions based on the determined importance level. When a new alert instruction is generated, the new alert instruction may be queued based the order of importance.

In an aspect, at 412 the apparatus may generate the alert based on the alert instruction. For example, the alert may be a sound generated at a particular volume by a speaker of the apparatus, a message displayed on a display of the apparatus, a blinking pattern created by an LED of the apparatus, or a vibration pattern generated by a vibration motor of the apparatus, or any combination of these examples. In an example, the apparatus may generate the alert based on the alert instruction's arrangement in a queue. In some aspects, the apparatus may transmit the alert instructions to the one or more coupled devices and allow the one or more coupled devices to generate the alert based on the alert instruction. For example, once the apparatus has retrieved connection information from the one or more devices coupled to the apparatus, the apparatus may determine to transmit the alert instructions to the one or more devices. In an example, the determination may be based on the proximity of the one or more devices to the apparatus at a current time or at a past time. When the one or more devices are at a distance greater than a predetermined distance, the apparatus may transmit the alert instructions such that the one or more devices generates an alert based on the alert instructions. In another example, the determination may be based on the recipient of the message being a current user of the one or more devices.

In an aspect, at 420 the apparatus may obtain third information including at least one of a power state of the device or an amount of data remaining in a data plan associated with the device, wherein the one or more characteristics is further based on the third information. In this example, the apparatus may determine the power state of the apparatus or an amount of data remaining in a data plan to be used when generating the alert instruction. Examples of the determining the power state include determining a battery level of the apparatus, a recent change of the power state of the apparatus (e.g., recently turned on or fully powered), or a current power state (e.g., low power mode). The third information may be used by the apparatus when generating the alert instructions. For example, when generating the alert instruction, the apparatus may determine that the apparatus was recently turned on, and therefore include delay times or scheduled times in the alert instructions of lower priority alerts.

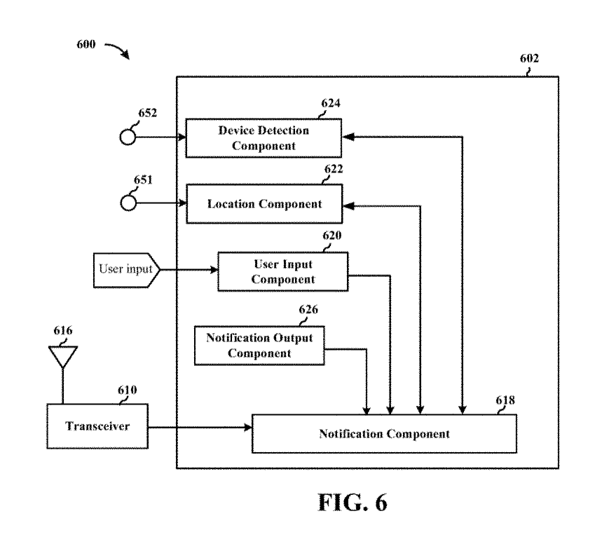

FIG. 6 is a conceptual data flow diagram 600 illustrating the data flow between different modules/means/components in an exemplary apparatus 602. The apparatus 602 may be the UE 104 or the apparatuses 202, 302 described with FIGS. 1-3. In an example, the apparatus 602 may be the processors 218, 318 of FIGS. 2-3. The apparatus 602 may include a notification component 618, a user input component 620, a location component 622, and a device detection component 624. In some examples, the apparatus 602 may include the sensors 651 and/or 652.

The notification component 618 may be configured to monitor for received messages (e.g., messages received via transceiver 610) to determine whether a message is received. The notification component 618 may also be configured to obtain first information associated with a recipient of a message received on the device (e.g., perform the functions associated with 402). For example, the notification component 618 may scan past messages to determine behavioral information of a user based on the user's interests based on types of applications, message senders, general interests of the user, location, or time/or date. The notification component 618 may also be configured to generate an alert instruction for indicating that the message is received (e.g., perform the functions associated with 410). When generating the alert instructions, the notification component 618 may generate the instructions based on the determined behavioral information.

The user input component 620 may receive, in some examples, user input for notification adjustments. For example, the user input component 620 may receive user inputs for a minimum or maximum volume of an alert or types of alerts to be used by the apparatus. Further, the user input component 620 may capture user interests input to web browsers or other applications of the apparatus 602. The user input data received by the user input component 620, may be shared with the notification component 618.

The location component 622 is configured to detect a location of the apparatus 602 with the sensor 651. An example of the sensor 651 may include location sensor 214. The location component 622 may monitor data from the sensor 651. The location component 622 may further detect a variation of the physical characteristic to a reference point. In an example, the location component may receive a communication from the notification component 618 to transmit a current location, when the notification component 618 has received a message. In response, the location component 622 may transmit the current location to the notification component 618.

The device detection component 624 is configured to detect a device coupled to the apparatus 602 via sensor 652. An example of the sensor 652 may include device detection sensor 216. In an example, the device detection component 624 is configured to retrieve connection information from a device coupled to the apparatus 602 (e.g., perform functions associated with 502-506) through one or more wireless protocols. The connection information may be in reference to a location or proximity of the device in relation to the apparatus 602 at a time a message is received by the apparatus 602. In some examples, the device detection component 624 may detect or sense an activity or movement of the device coupled to the apparatus 602, in relation to the apparatus 202 and the location may be based on the detected activity or movement. Examples of the device detection component 624 may include a Bluetooth tracking technology, a radio frequency identification (RFID) tracking technology, wireless fidelity (Wi-Fi) tracking technology, or any technology that facilitates the apparatus 602 in receiving connection and/or location characteristics of one or more coupled devices. The device detection component 624 may communicate the data to the notification component 618.

The notification output component 626 may be configured to output an alert based on alert instructions. The notification output component 626 may receive the alert instructions from the notification component 618. Examples of the notification output component 626 may include the notification output component 230.

The apparatus may include additional components or modules that perform each of the blocks of the algorithm in the aforementioned flow charts of FIGS. 4, 5A-5B. As such, each block in the aforementioned flowchart of FIGS. 4, 5A-5B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof. For example, the processor 218 may perform the functions of one or more of the notification component 618, the user input component 620, the location component 622, and the device detection component 624 or one or more other processors may perform one or more of these functions.

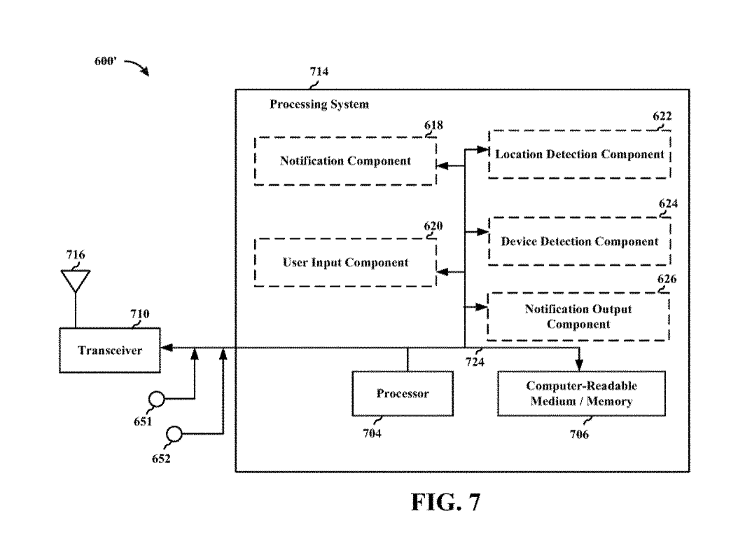

FIG. 7 is a diagram illustrating an example of a hardware implementation for an apparatus 600′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 618-626, and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 716. The transceiver 710 provides a means for communicating with various other apparatuses over a transmission medium. The transceiver 710 receives a signal from the one or more antennas 716, extracts information from the received signal, and provides the extracted information to the processing system 714. In addition, the transceiver 710 receives information from the processing system 714, and based on the received information, generates a signal to be applied to the one or more antennas 716.

The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described infra for any particular apparatus. The computer-readable medium/memory 706 may also be used for storing data that is manipulated by the processor 704 when executing software. The processing system 714 may further includes at least one of the notification component 618, the user input component 620, the location detection component 622, the device detection component 624, and the notification output component 626. The components may be software components running in the processor 704, resident/stored in the computer readable medium/memory 706, one or more hardware components coupled to the processor 704, or some combination thereof. The processing system 714 may be a component of a UE 104 or apparatus 202.

In some examples, the apparatus 600′ may include the sensors 651, 652. The sensor 651 may detect a location of the apparatus 600′. An example of the sensor 651 may include the sensor 214. The sensor 652 may detect a device or devices coupled to the apparatus 600′. An example of the sensor 652 may include the sensor 216.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of notification of a message received on a first device, comprising:
obtaining first information associated with a recipient of the message received on the first device;
obtaining second information associated with the message;
determining a context of the message based on the first information and the second information;
determining an importance level of the message based on the context; and
generating an alert instruction for indicating that the message is received, the alert instruction including one or more characteristics of an alert, the one or more characteristics based on the importance level.

2. The method of claim 1, wherein the obtaining the second information comprises obtaining at least one of a date, a time, or a time zone when the message was transmitted or a location from where the message was transmitted.

3. The method of claim 2, wherein the obtaining the second information further comprises transmitting a prompt to a sender of the message requesting for the location from where the message was transmitted.

4. The method of claim 3, wherein the transmitting the prompt comprises requesting for auto detection of the location.

5. The method of claim 1, wherein the obtaining the first information comprises retrieving connection information associated with one or more devices coupled to the first device and used by the recipient.

6. The method of claim 5, wherein the retrieving the connection information comprises retrieving the connection information from the one or more devices or from a central server.

7. The method of claim 5, wherein the retrieving the connection information comprises retrieving a proximity of the one or more devices to the first device based on a current time or a past time.

8. The method of claim 5, wherein the recipient is one of a first plurality of users of the first device and one of a second plurality of users of the one or more devices coupled to the first device.

9. The method of claim 8, further comprising:
determining that a device, from the first device or the one or more devices coupled to the first device, is currently being used by the recipient; and
generating the alert based on the alert information when the determined device is the first device, or
transmitting the alert information to the determined device when the determined device is one of the one or more devices coupled to the first device.

10. The method of claim 1, further comprising obtaining third information including at least one of a power state of the first device or an amount of data remaining in a data plan associated with the first device, wherein the one or more characteristics is further based on the third information.

11. The method of claim 1, wherein the obtaining the first information comprises obtaining past messages associated with the recipient to determine interests of the recipient.

12. The method of claim 1, further comprising generating the alert based on the alert instruction.

13. The method of claim 12, wherein the generating the alert is further based on a priority of the message for the recipient.

14. The method of claim 1, wherein the first information includes calendar application data, and the second information includes at least one of a location of a sender of the message or a location of the recipient, wherein the determining the context of the message is based on a relationship of the calendar application data to the at least one of the location of the sender or the location of the recipient.

15. An apparatus for providing an alert, comprising:
a memory;
at least one processor coupled to the memory and configured to:
obtain first information associated with a recipient of a message received on the apparatus;
obtain second information associated with the message;
determine a context of the message based on the first information and the second information;
determine an importance level of the message based on the context; and
generate an alert instruction for indicating that the message is received, the alert instruction including one or more characteristics of the alert, the one or more characteristics based on the importance level.

16. The apparatus of claim 15, wherein the at least one processor is further configured to obtain at least one of a date, a time, or a time zone when the message was transmitted or a location from where the message was transmitted.

17. The apparatus of claim 16, wherein the at least one processor is further configured to transmit a prompt to a sender of the message requesting for the location from where the message was transmitted.

18. The apparatus of claim 17, wherein the at least one processor is further configured to request for auto detection of the location.

19. The apparatus of claim 15, wherein the at least one processor is further configured to retrieve connection information associated with one or more devices coupled to the apparatus and used by the recipient.

20. The apparatus of claim 19, wherein the at least one processor is further configured to retrieve the connection information from the one or more devices or from a central server.

21. The apparatus of claim 19, wherein the at least one processor is further configured to retrieve a proximity of the one or more devices to the apparatus based on a current time or a past time.

22. The apparatus of claim 19, wherein the recipient is one of a first plurality of users of the apparatus and one of a second plurality of users of the one or more devices coupled to the apparatus.

23. The apparatus of claim 22, wherein the at least one processor is further configured to:
determine that a device, from the apparatus or the one or more devices coupled to the apparatus, is currently being used by the recipient; and
generate the alert based on the alert information when the determined device is the apparatus, or
transmit the alert information to the determined device when the determined device is one of the one or more devices coupled to the apparatus.

24. The apparatus of claim 15, wherein the at least one processor is further configured to obtain third information including at least one of a power state of the apparatus or an amount of data remaining in a data plan associated with the apparatus, wherein the one or more characteristics is further based on the third information.

25. The apparatus of claim 15, wherein the at least one processor is further configured to obtain past messages associated with the recipient to determine interests of the recipient.

26. The apparatus of claim 15, wherein the at least one processor is further configured to generate the alert based on the alert instruction.

27. The apparatus of claim 26, wherein the at least one processor is further configured to generate the alert based on a priority of the message for the recipient.

28. The apparatus of claim 15, wherein the first information includes calendar application data, and the second information includes at least one of a location of a sender of the message or a location of the recipient, wherein the at least one processor determines the context of the message is based on a relationship of the calendar application data to the at least one of the location of the sender or the location of the recipient.

29. An apparatus for providing an alert, comprising:
means for obtaining first information associated with a recipient of a message received on the apparatus;
means for obtaining second information associated with the message;
means for determining a context of the message based on the first information and the second information;
means for determining an importance level of the message based on the context; and
means for generating an alert instruction for indicating that the message is received, the alert instruction including one or more characteristics of the alert, the one or more characteristics based on the importance level.

30. The apparatus of claim 29, wherein the means for obtaining the second information comprises means for obtaining at least one of a date, a time, or a time zone when the message was transmitted or a location from where the message was transmitted.

31. The apparatus of claim 30, further comprising means for transmitting a prompt to a sender of the message requesting for the location from where the message was transmitted.

32. The apparatus of claim 31, wherein the means for transmitting the prompt is configured to request an auto detection of the location.

33. The apparatus of claim 29, wherein the means for obtaining the first information is configured to retrieve connection information associated with one or more devices coupled to the apparatus and used by the recipient.

34. The apparatus of claim 33, wherein the means for retrieving the connection information is further configured to retrieve the connection information from the one or more devices or from a central server.

35. The apparatus of claim 33, wherein the means for retrieving the connection information is further configured to retrieve a proximity of the one or more devices to the apparatus based on a current time or a past time.

36. The apparatus of claim 33, wherein the recipient is one of a first plurality of users of the apparatus and one of a second plurality of users of the one or more devices coupled to the apparatus.

37. The apparatus of claim 36, further comprising:
means for determining that a device, from the apparatus or the one or more devices coupled to the apparatus, is currently being used by the recipient;
means for generating the alert based on the alert information when the determined device is the apparatus; and
means for transmitting the alert information to the determined device when the determined device is one of the one or more devices coupled to the apparatus.

38. The apparatus of claim 29, further comprising means for obtaining third information including at least one of a power state of the apparatus or an amount of data remaining in a data plan associated with the apparatus, wherein the one or more characteristics is further based on the third information.

39. The apparatus of claim 29, wherein the means for obtaining the first information is configured to obtain past messages associated with the recipient to determine interests of the recipient.

40. The apparatus of claim 29, further comprising means for generating the alert based on the alert instruction.

41. The apparatus of claim 40, wherein the means for generating the alert is configured to generate the alert based on a priority of the message for the recipient.

42. The apparatus of claim 29, wherein the first information includes calendar application data, and the second information includes at least one of a location of a sender of the message or a location of the recipient, wherein the means for determining the context of the message includes determining the context based on a relationship of the calendar application data to the at least one of the location of the sender or the location of the recipient.

43. A computer-readable medium storing computer executable code, comprising code for:
obtaining first information associated with a recipient of a message received on a first device;
obtaining second information associated with the message;
determining a context of the message based on the first information and the second information;
determining an importance level of the message based on the context; and
generating an alert instruction for indicating that the message is received, the alert instruction including one or more characteristics of an alert, the one or more characteristics based on the importance level.
